(19) United States
(12) Patent Application Publication
(10) Pub. No.: US 2014/0250808 A1
(43) Pub. Date: Sep. 11, 2014

(54) FOAM ORNAMENT SURFACE ENHANCING METHOD AND EXTERIOR WALL DECORATIVE FOAM MANUFACTURED BY THE SAME

(71) Applicant: MOSPEN PRODUCTS COMPANY, TAIPEI (TW)

(72) Inventor: CHASON YEN, TAIPEI (TW)

(73) Assignee: MOSPEN PRODUCTS COMPANY, TAIPEI (TW)

(21) Appl. No.: 13/787,846

(22) Filed: Mar. 7, 2013

(51) Int. Cl. B29C 41/00; B29C 41/22; E04B 1/70

(52) U.S. Cl. CPC B29C 41/003; E04B 1/70; B29C 41/22
USPC 52/302.1; 264/45.1

(57) ABSTRACT

A foam ornament surface enhancing method includes the steps of: providing a pigment, a PU protective material, a PU supportive material and a mold; spraying the pigment into the mold; spraying the PU protective material onto a side of the pigment; casting the PU supportive material into the mold within a first predetermined time; and letting the materials sit still for a second predetermined time to dry the PU protective material and the PU supportive material sufficiently to manufacture the foam ornament. The PU protective material can protect the foam ornament from UV exposure and enhance the surface strength and flame retardation effect, so as to enhance the service life, aesthetic appearance and surface texture.

### BACKGROUND OF THE INVENTION

1. Field of the Invention

The present invention relates to the manufacture of foam products, and more particularly to a foam ornament surface enhancing method and an exterior wall decorative foam manufactured by the method, and the finished goods manufactured according to this method can be ultraviolet (UV)-resistant, impact-resistant and flame-retardant to improve the practicability significantly.

2. Description of the Related Art

Foam ornaments are often used for the purposes of architectural decoration and garden landscaping, and common foam ornaments of this sort including decorative exterior walls, insulating panels, decorative covers or verisimilitude rocks are used to substitute wood, anti-corrosive wood and real rocks, and these foam ornaments have the advantages of high corrosion resistance, low maintenance rate and low deformation rate, as well as the waterproof, anti-mildew, anti-pest and insulating features. In addition, 100% of the waste material of the foam ornaments can be recycle and reused, and the aforementioned foam ornaments fully comply with the requirements of carbon reduction, environmental protection, recycle and reuse, and thus the foam ornaments become favorite in Europe and the United States in recent years.

In general, decorative wall panels or insulating panels are mounted onto a wall and formed by stacking a foam body, an enhanced layer and a coating layer sequentially, wherein the backside of the foam body is mounted onto the wall, and a surface of the foam body is a decorative layer which shows a rock or soil like texture on the surface of the foam body by a molding or manual cutting method, and a surface of the decorative layer is sprayed or coated with an enhanced layer and a coating layer. The enhanced layer can isolate the surface of the foam body from being in a direct contact with external ultraviolet (UV) or water to prevent the problems of aging and damaging the surface of the foam body. In addition, the coating layer is provided for improving the effect of veins and colors of the decorative layer.

After the decorative wall panels or insulating panels are mounted onto an exterior wall of a building, the exterior wall of the building will look like rock or wood and also have the insulation function to keep room temperature within a comfortable range without requiring air-conditioning while the sun shines. Therefore, these wall panels can achieve the carbon-reduction and power saving effects.

However, after the coating layer and/or the enhanced layer have been used or exposed in wind, rain and sun for a long time, the surface of the foam body may peel off, not only reducing the aesthetic look significantly, but also losing the protective function of the foam body. Although foam does not absorb water and has a waterproof effect, the foam is a porous material property, so that water is accumulated in pores of the foam easily to link to a variety of problems such as mildew, fouling and moss. Obviously, such conventional exterior wall decorative foam requires improvements.

### SUMMARY OF THE INVENTION

In view of the problems of the prior art, it is a primary objective of the present invention to overcome the problems of the prior art by providing a foam ornament surface enhancing method, wherein a polyurethane (PU) protective material is added to the external surface of the polyurethane (PU) supportive material in the foaming process of the PU supportive material, and the PU protective material has the feature of combining with the PU supportive material perfectly, so as to achieve the effects of resisting UV exposure, enhancing surface strength, and retarding flame. Further, a layer of pigment is coated onto a surface of the PU protective material to improve the aesthetic appearance and the simulation result of the foam ornament.

To achieve the aforementioned objective, the present invention provides a foam ornament surface enhancing method, comprising the steps of: providing a pigment, a PU protective material, a PU supportive material and a mold, wherein the mold has at least one mold cavity; spraying the pigment onto a surface of the mold cavity and dispersing the pigment onto the surface of the mold cavity uniformly; spraying the PU protective material on a side of the pigment according to a predetermined weight ratio until the PU protective material is completely covered onto the pigment, so that the PU protective material and the pigment are combined integrally; casting the PU supportive material into the mold cavity within a first predetermined time according to the predetermined weight ratio, so that the PU protective material and the PU supportive material are combined integrally; and letting the PU protective material and the PU supportive material sit still for a second predetermined time, so that the PU protective material and the PU supportive material are sufficiently dried to manufacture the foam ornament, wherein the PU protective material carries out a micro-foaming reaction, and the PU supportive material carries out a foaming reaction.

In a preferred embodiment, the PU protective material is formed by mixing in a weight ratio of 1:1. The PU protective material is reacted at a predetermined temperature within a range of 25° C.˜40° C.

The PU protective material is reacted at a predetermined temperature falling within a range of 25° C.˜40° C.

Since the PU protective material carries out the reaction only at the predetermined temperature, a step of “preheating the mold until the temperature of the mold reaches the predetermined temperature” is added before the step of “spraying the PU protective material on a side of the pigment according to a predetermined weight ratio until the PU protective material is completely covered onto the pigment, so that the PU protective material and the pigment are combined integrally”. As a result, the PU protective material can be reacted completely and integrally combined with the pigment and the PU supportive material.

In the present invention, the predetermined weight ratio is a weight ratio of the PU protective material to the PU supportive material falling within a range of 1:6˜1:4.6, and the first predetermined time falls within a range of 15˜30 seconds, and the second predetermined time falls within a range of 15˜30 minutes to achieve the best manufacturing effect.

Another objective of the present invention is to provide an exterior wall decorative foam manufactured by the foam ornament surface enhancing method, wherein a plurality of drainage structures is protruded from a mounting surface and coupled parallelly with one another, and each of the drainage structures includes a water collection part and a ditch to form a Y-shape, so that water can be collected and guided effectively and discharged through the ditch, while maintaining a vast majority of the area of the mounting surface dry. Therefore, the invention can prevent mildew and moss and extend the service life effectively. In addition, the drainage structures are arranged in parallel to one another to improve the overall strength.

To achieve the aforementioned objective, the present invention provides a exterior wall decorative foam, installed on a wall as a decoration, and comprising: a wall panel, manufactured by being integrally combined with the PU supportive material, and having a decorative surface and a mounting surface, and the mounting surface being disposed correspondingly to the wall and having a plurality of drainage structures, and the drainage structures being coupled in parallel to one another, and each of the drainage structures including a water collection part and a ditch part, and the water collection part being extended outwardly and spread open into a V-shape, and the ditch part being disposed at a folding position of the water collection part to make the drainage structure into a Y-shape, and a portion of the mounting surface without the drainage structures being a dry area; a protective layer, covered onto the decorative surface, made of the PU protective material, integrally combined with the wall panel; and a decorative layer, covered onto an external surface of the protective layer, made of the pigment, and integrally combined with the protective layer.

Wherein, the water collection parts have a total area equal to 10%˜25% of a total area of the mounting surface, and the drainage structure is coated with a waterproof coating. Each of the water collection parts has a predetermined angle falling within a range of 30-120 degrees, and preferably 90 degrees

### BRIEF DESCRIPTION OF THE DRAWINGS

FIG. 1 is a flow chart of a preferred embodiment of the present invention;

FIG. 2 is a schematic view of a status corresponding to Step S01 of the flow chart;

FIG. 3 is a schematic view of a status corresponding to Step S02 of the flow chart;

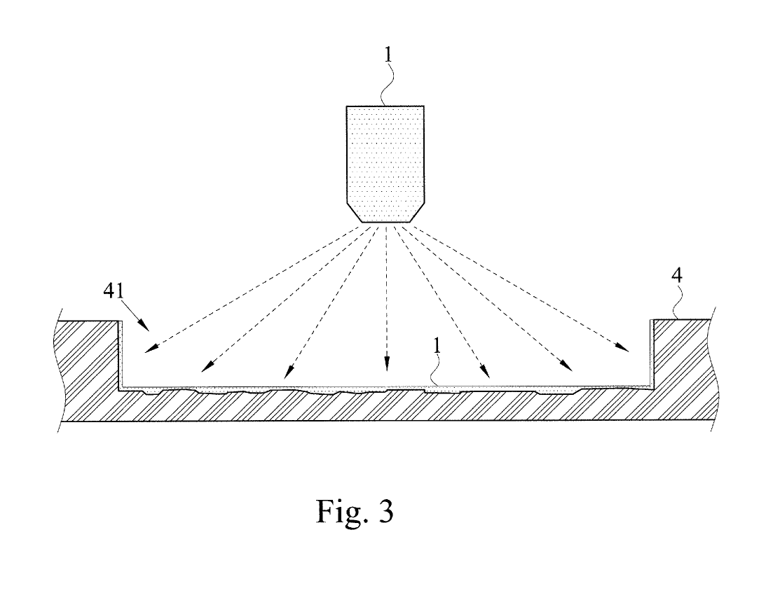

FIG. 4 is a schematic view of a status corresponding to Step S03 of the flow chart;

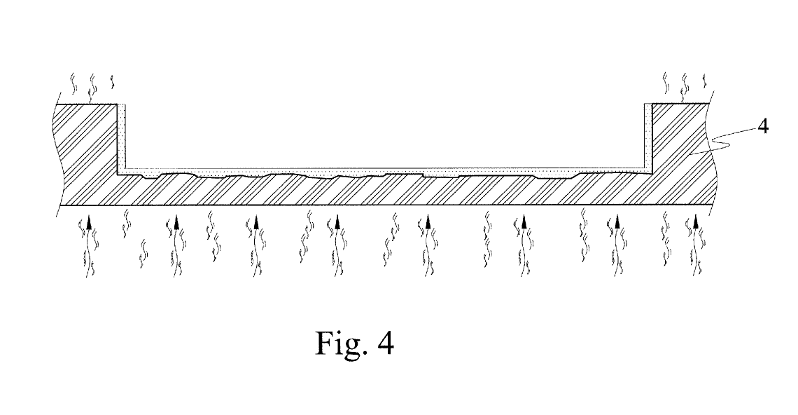

FIG. 5 is a schematic view of a status corresponding to Step S04 of the flow chart;

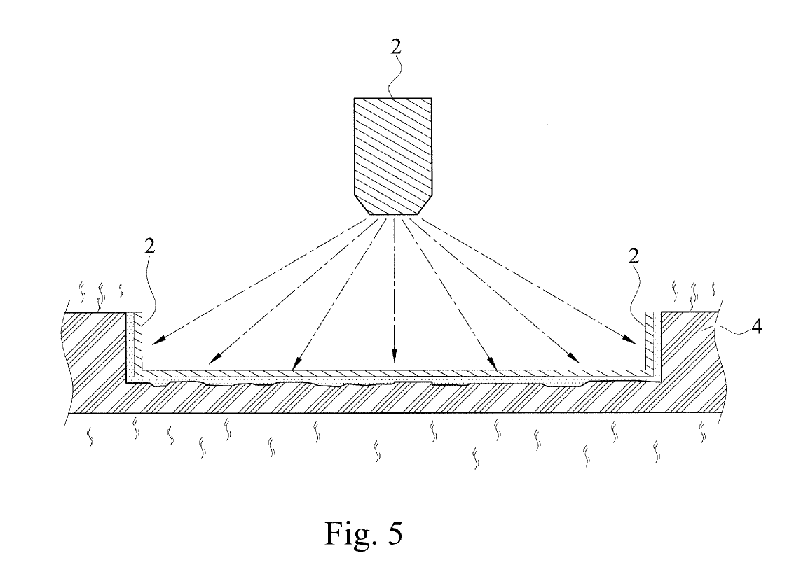

FIG. 6 is a schematic view of a status corresponding to Step S05 of the flow chart;

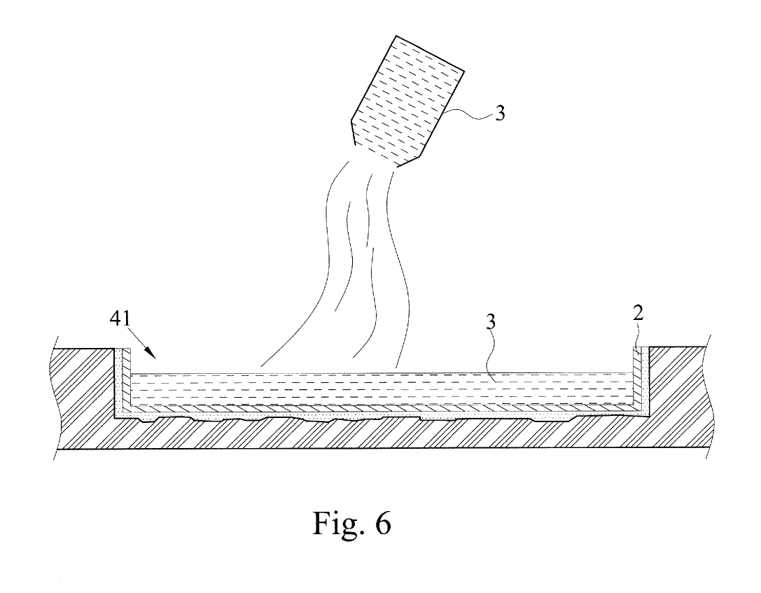

FIG. 7 is a schematic view of a status corresponding to Step S06 of the flow chart;

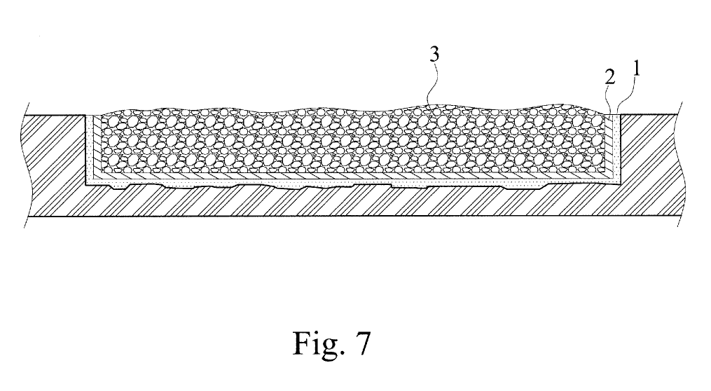

FIG. 8 is a first schematic view of a preferred embodiment of the present invention; and

FIG. 9 is a second schematic view of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

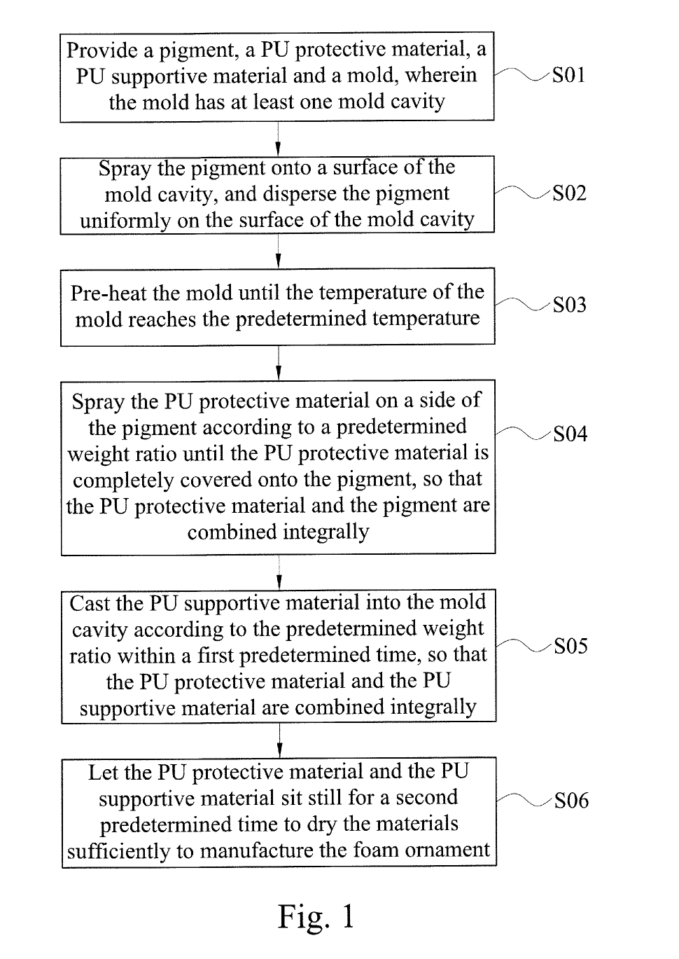

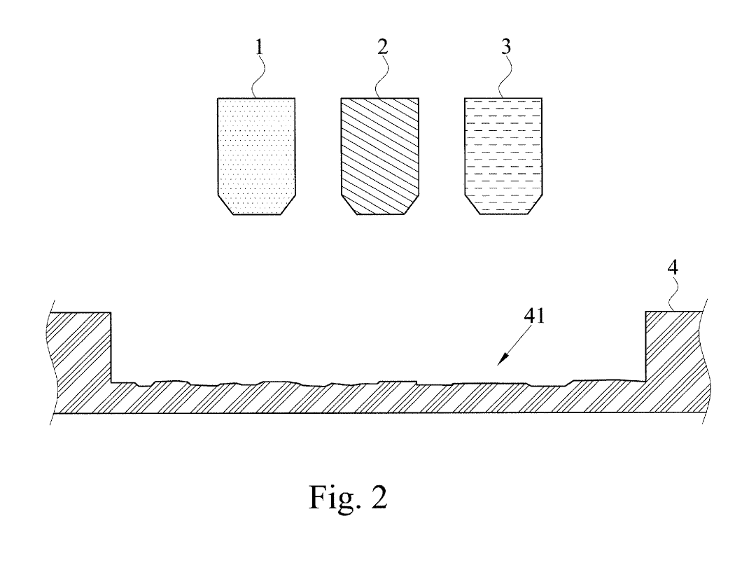

With reference to FIGS. 1 and 2˜7 for a flow chart and schematic views of each step of the flow in accordance with a preferred embodiment of the present invention respectively, the foam ornament surface enhancing method of the present invention comprises the following steps:

S01: Provide a pigment 1, a PU protective material 2, a PU supportive material 3 and a mold 4, wherein the mold 4 has at least one mold cavity 41. Experiments show that the PU protective material 2 used in the present invention is formed by mixing ELASTOCOAT® T774 530 LB and ELASTOCOAT® R774D60-FR-30S LGY 470 LB in a weight ratio of 1:1. The PU protective material 2 is combined with the PU supportive material 3 to provide the best effect, and the PU protective material is reacted at a predetermined temperature which falls within a range of 25° C.˜40° C.

S02: Spray the pigment 1 onto a surface of the mold cavity 41, and disperse the pigment 1 uniformly on the surface of the mold cavity 41. Wherein, the pigment 1 comprises color paint and powdery particles, so that the finished good has a surface with a simulated rock texture.

S03: Pre-heat the mold 4, until the temperature of the mold 4 reaches the predetermined temperature.

S04: Spray the PU protective material 2 on a side of the pigment 1 according to a predetermined weight ratio until the PU protective material is completely covered onto the pigment, so that the PU protective material 2 and the pigment 1 are combined integrally. Since the previous step has preheated the mold 4 until its temperature reaches the predetermined temperature, therefore when the PU protective material 2 is coated onto the pigment 1, the PU protective material 2 and the pigment 1 can be combined sufficiently due to the temperature of the mold 4.

S05: Cast the PU supportive material 3 into the mold cavity 41 according to the predetermined weight ratio within a first predetermined time, so that the PU protective material 2 and the PU supportive material 3 are combined integrally. To avoid the PU protective material 2 from being reacted completely and shaped, the PU supportive material 3 must be casted within the first predetermined time in this step. Experiments show that the first predetermined time preferably falls within a range of 15 seconds˜30 seconds. To take both manufacturing cost and quality into consideration, a predetermined weight ratio of the PU protective material 2 to the PU supportive material 3 is used for the manufacture, wherein this ratio preferably falls within a range of 1:6˜1:4.6.

S06: Let the PU protective material 2 and the PU supportive material 3 sit still for a second predetermined time to dry the PU protective material 2 and the PU supportive material 3 sufficiently to manufacture the foam ornament, wherein the PU protective material 2 carries out a micro-foaming reaction, and the PU supportive material 3 carries out a foaming reaction. Experiments show that the second predetermined time preferably falls within a range of 15˜30 minutes for a sufficient dry, and the pigment 1 can be fixed onto the surface of the PU protective material 2 securely.

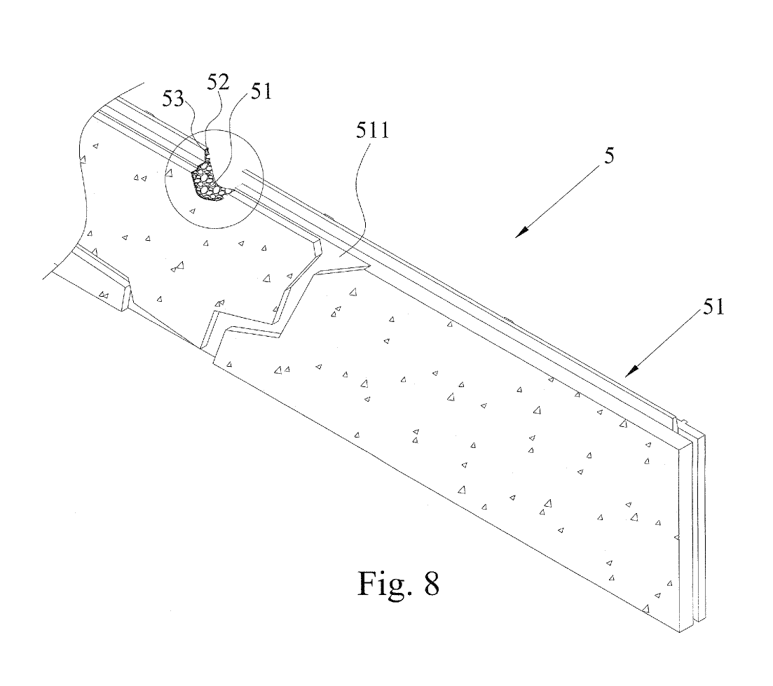

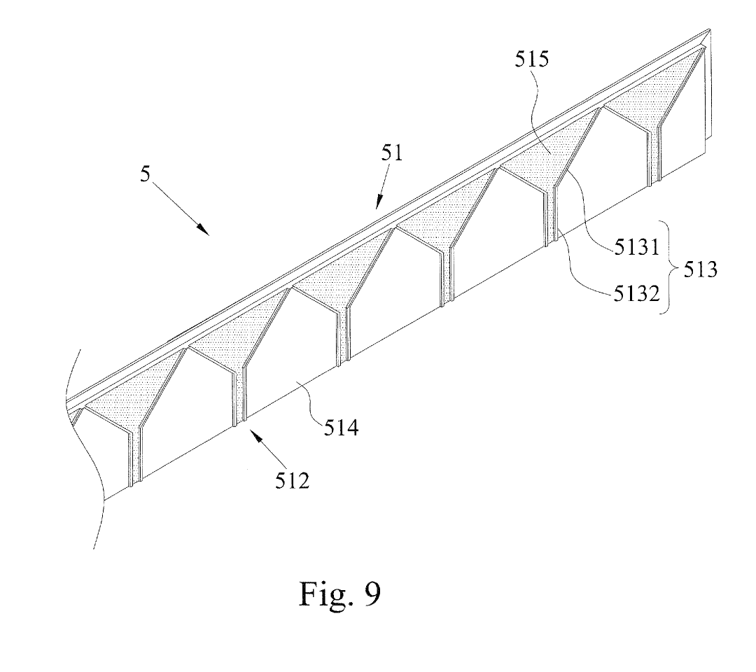

With reference to FIGS. 8 and 9, an exterior wall decorative foam 5 manufactured according to the aforementioned foam ornament surface enhancing method is installed on a wall as a decoration, and the exterior wall decorative foam 5 comprises a wall panel 51, a protective layer 52 and a decorative layer 53.

Wherein, the wall panel 51 is made of the PU supportive material 3 and integrally formed according to the shape of the mold 4 (not shown in the figure), and the wall panel 51 has a decorative surface 511 and a mounting surface 512. The mounting surface 511 is disposed correspondingly to the wall and has a plurality of drainage structures 513, and the drainage structures 513 are coupled in parallel to one another, and each of the drainage structures 513 includes a water collection part 5131 and a ditch part 5132, and the water collection part 5131 is extended outwardly and spread open into a V-shape, and the ditch part 5132 is disposed at a folding position of the water collection part 5131 to make the drainage structure 513 into a Y-shape, and a portion of the mounting surface 511 without the drainage structures 513 is a dry area 514.

The protective layer 52 is covered onto the decorative surface 511, made of the PU protective material 2, and integrally combined with the wall panel 51.

The decorative layer 53 is covered onto an external surface of the protective layer 52, and the decorative layer 53 is made of the pigment 1 and integrally combined with the protective layer 52.

In addition, the water collection parts 5131 has a total area equal to 10%˜25% of a total area of the mounting surface 512, and the drainage structure 513 is coated with a waterproof coating 515. It is noteworthy that the water collection part 5131 has a predetermined angle falling within a range of 30˜120 degrees, and preferably 90 degrees to improve the water collection and drainage effects, such that water can be guided along the water collection part 5131 and collected effectively, and finally discharged from the ditch part 5132.

What is claimed is:

1. (canceled)

2. (canceled)

3. (canceled)

4. (canceled)

5. (canceled)

6. (canceled)

7. (canceled)

8. An exterior wall decorative foam provided for installing on a wall as a decoration, comprising:
a wall panel, manufactured by being integrally combined with a PU supportive material, and having a decorative surface and a mounting surface, and the mounting surface having a plurality of drainage structures corresponding to the wall, and the plurality of drainage structures being coupled in parallel to one another, and each of the plurality of drainage structures including a water collection part and a ditch part, and the water collection part being extended outwardly and spread open into a V-shape, and the ditch part being disposed at a folding position of the water collection part to make the plurality of drainage structure into a Y-shape, and a portion of the mounting surface without the drainage structures being a dry area, wherein the water collection part is disposed at an upper boarder of the mounting surface;
a protective layer, covered onto the decorative surface, made of the PU protective material, integrally combined with the wall panel; and
a decorative layer, covered onto an external surface of the protective layer, made of a pigment, and integrally combined with the protective layer,
wherein the PU protective material is formed by mixing ELASTOCOAT® T774 530 LB and ELASTOCOAT® R774D60-FR-30S LGY 470 LB in a weight ratio of 1:1 at a predetermined temperature which falls within a range of 25° C.-40° C.

9. The exterior wall decorative foam of claim 8, wherein the water collection parts have a total area equal to 10%-25% of a total area of the mounting surface, and the drainage structure is coated with a waterproof coating.

10. The exterior wall decorative foam of claim 8, wherein the water collection part has a predetermined angle within a range of 30-120 degrees.
